(19) United States
(12) Patent Application Publication
(10) Pub. No.: US 2012/0032772 A1
(43) Pub. Date: Feb. 9, 2012

(54) JOINING A CURRENT LIMITING DEVICE AND A FUSE

(75) Inventors: Richard J. Smith, Waukesha, WI (US); Wayne W. Lien, Laurel, MS (US)

(73) Assignee: Cooper Technologies Company, Houston, TX (US)

(21) Appl. No.: 12/850,295

(22) Filed: Aug. 4, 2010

(51) Int. Cl. H01H 85/02

(52) U.S. Cl. 337/207; 337/171

(57) ABSTRACT

An assembly includes an electrically conductive mounting bracket, a current limiting device electrically connected to the mounting bracket, and a fuse assembly that includes a body and a fuse. The electrically conductive mounting bracket is configured to mount about the body of the fuse assembly, and, when the electrically conductive mounting bracket is mounted about the body of the fuse assembly, the mounting bracket forms a path for electrical current between the current limiting device and the fuse.

### TECHNICAL FIELD

This description relates to joining a current limiting device and a fuse.

### BACKGROUND

A current limiting fuse may be electrically connected to a fuse included in a fuse holder and/or a fuse assembly by crimping a bare conductive metal strip, which is electrically connected to the current limiting fuse, onto the fuse holder or onto the fuse assembly.

### SUMMARY

A mounting bracket discussed below may be used to electrically and mechanically connect a fuse assembly and a current limiting device. The fuse assembly includes a fuse, a fuse holder, and a fuse housing, or body. The fuse assembly may be a bayonet fuse assembly and the current limiting device may be a current limiting fuse (CLF). The bayonet fuse assembly and the CLF may be placed in a fluid-filled tank of a transformer.

Previously, the fuse assembly and the current limiting device were connected with a conductive metal strip connected to the fuse holder, by, for example, a crimp connection. In contrast, the mounting bracket discussed below is secured about a body of the fuse assembly, thus eliminating the need for a crimp connection between the conductive metal strip and the fuse assembly. As compared to the mounting bracket, the crimp connection is more prone to failure, and failure of the crimp connection during use may cause the CLF to separate from the fuse assembly and drop to the floor of the tank. This separation may result in a line-to-ground fault and an arc through the bottom of the tank. Such a failure may cause catastrophic damage to the tank and/or components within and around the tank. The mounting bracket reduces, or eliminates, the possibility of this type of failure by securely mounting the CLF to the fuse assembly with a single conductive bracket that also provides an electrical connection between the CLF and the fuse within the fuse assembly.

Additionally, use of the mounting bracket may reduce or limit the amount of hardware required to place and secure the fuse assembly and the CLF in the tank, and may reduce the size of the tank due to the elimination of the conductive metal strip. Using the mounting bracket may also allow for quicker assembly of the fuse assembly and the CLF within the tank.

In some prior designs, the CLF was mounted onto the fuse assembly with a mounting bracket. However, in these designs, the mounting bracket does not provide an electrical connection between the CLF and the fuse included in the fuse assembly. Instead, these designs rely on a separate conductive cable to provide an electrical path from the CLF to the fuse. Without the separate conductive cable, these prior systems would not have an electrical connection between the CLF and the fuse, even if the mounting bracket could be made of a conductive material. In contrast to these designs, the mounting bracket discussed below provides both a physical and an electrical connection between the CLF and the fuse within the fuse assembly while eliminating the need for a separate conductive cable.

In one general aspect, an assembly includes an electrically conductive mounting bracket, a current limiting device electrically connected to the mounting bracket, and a fuse assembly that includes a body and a fuse. The electrically conductive mounting bracket is configured to mount about the body of the fuse assembly, and, when the electrically conductive mounting bracket is mounted about the body of the fuse assembly, the mounting bracket forms a path for electrical current between the current limiting device and the fuse.

Implementations may include one or more of the following features. The current limiting device may include a current limiting fuse. The current limiting fuse may include a protrusion configured to connect to a portion of the mounting bracket. The body of the fuse assembly may include a first contact and a second contact, both of which are electrically connected to the fuse, and the mounting bracket may be electrically connected to the first contact. The mounting bracket may be configured to hold the current limiting device at a predetermined angle relative to a longitudinal axis of the body of the fuse assembly.

In some implementations, the mounting bracket may include an end, a first side connected to the end, and a second side connected to the end. The first side and the second side may define an opening that is configured to be placed about the body of the fuse assembly. The mounting bracket may be formed from a single piece. A bore configured to receive a portion of the current limiting device may be formed in the end of the mounting bracket, a first opening may be formed in the first side of the mounting bracket, and a second opening may be formed in the second side of the mounting bracket. The first opening may include two separate openings that pass through the first side of the mounting bracket, and the second opening may include two separate openings that pass through the second side of the mounting bracket. A fastener may connect one of the openings on the first side of the mounting bracket to one of the openings on the second side of the mounting bracket to secure the mounting bracket about the body of the fuse assembly. A conductive connector may be accepted into the other one of the openings on either of the first side and the second side to make an electrical connection to the fuse included in the fuse assembly.

In some implementations, the fuse assembly may include a first contact and a second contact, both of which are electrically connected to the fuse, and the fuse assembly may withstand up to a first potential difference between the first contact and the second contact without producing an arc between the first contact and the second contact. The body of the fuse assembly may further include a voltage grading configured to allow the fuse assembly to withstand a second potential difference between the first contact and the second contact without producing an arc between the first contact and the second contact. The second potential difference may be greater than the first potential difference. The voltage grading may include a voltage grading spring. The voltage grading may be formed by rounding a portion of an edge of the mounting bracket. The voltage grading may include a skirt that increases a creep distance between the mounting bracket and one of the first and second contacts and that is included on the body of the fuse assembly.

In another general aspect, a mounting bracket for electrically and mechanically connecting a current limiting device to a body of a fuse assembly includes an end portion configured to join the mounting bracket to the current limiting device and, once joined, to electrically connect the mounting bracket to the current limiting device. The mounting bracket also includes a side portion attached to the end portion and configured to mount about the body of the fuse assembly such that, once the side portion is mounted about the body, a path for electrical current is formed between a fuse included in the fuse assembly, the mounting bracket, and the current limiting device.

Implementations may include one or more of the following features. The mounting bracket may include a second side portion connected to the end portion, and the second side portion may be substantially parallel to the side portion. The end portion may be angled relative to the side portion such that, once the side portion is mounted about the body, the current limiting element is held at an angle relative to a longitudinal axis of the body of the fuse assembly. The side portion may include a rounded edge.

In another general aspect, a method of electrically and mechanically connecting a current limiting device to a fuse included in a fuse assembly includes coupling a mounting bracket to the current limiting device such that the mounting bracket is secured to and electrically connected to the current limiting device, and mounting the mounting bracket about a body of the fuse assembly such that the mounting bracket is secured about the fuse holder and an electrical path is formed between the current limiting device, the mounting bracket, and the fuse.

In another general aspect, a system includes a tank, a fuse assembly mounted in the tank, a mounting bracket mounted about the body of the fuse assembly, and a current limiting device electrically and mechanically coupled to a fuse within the fuse assembly through the mounting bracket, the mounting bracket holding the current limiting device at an angle relative to a longitudinal axis of the body of the fuse assembly.

In some implementations, the fuse assembly may be mounted through one of a side wall or a top of the tank.

Implementations of any of the techniques described above may include a method, a process, a system, a device, an apparatus, or a mounting bracket. The details of one or more implementations are set forth in the accompanying drawings and the description below. Other features will be apparent from the description and drawings, and from the claims.

### DESCRIPTION OF THE DRAWINGS

FIG. 1 shows an example of a system that includes a mounting bracket mounted to a fuse assembly.

FIG. 2 shows a cross-sectional view of the fuse assembly of FIG. 1.

FIG. 3A shows a developed view of the mounting bracket of FIG. 1.

FIG. 3B shows a formed view of the mounting bracket of FIG. 1.

FIG. 3C shows a perspective view of the mounting bracket of FIG. 1.

FIGS. 4 and 5 show perspective views of the mounting bracket of FIG. 1.

FIG. 6 shows a cross-sectional view of an exemplary current limiting device.

FIG. 7A shows a developed view of another mounting bracket.

FIG. 7B shows a formed view of the mounting bracket of FIG. 7B.

FIG. 7C shows a perspective view of the mounting bracket of FIG. 7B.

FIG. 7D shows a rounded edge of the mounting bracket taken along line B of FIG. 7B.

FIGS. 8 and 9 show a spring that forms a voltage grading.

FIG. 10 shows a fuse holder that includes a voltage grading.

FIG. 11 shows an example process for connecting a current limiting device to a fuse.

FIG. 12A shows an alternative exemplary system that includes a mounting bracket mounted to a fuse assembly.

FIG. 12B shows a developed view of the mounting bracket shown in FIG. 12A.

FIG. 12C shows a formed view of the mounting bracket shown in FIG. 12A.

FIG. 12D shows a perspective view of the mounting bracket shown in FIG. 12A.

Like reference symbols in the various drawings may indicate like elements.

### DETAILED DESCRIPTION

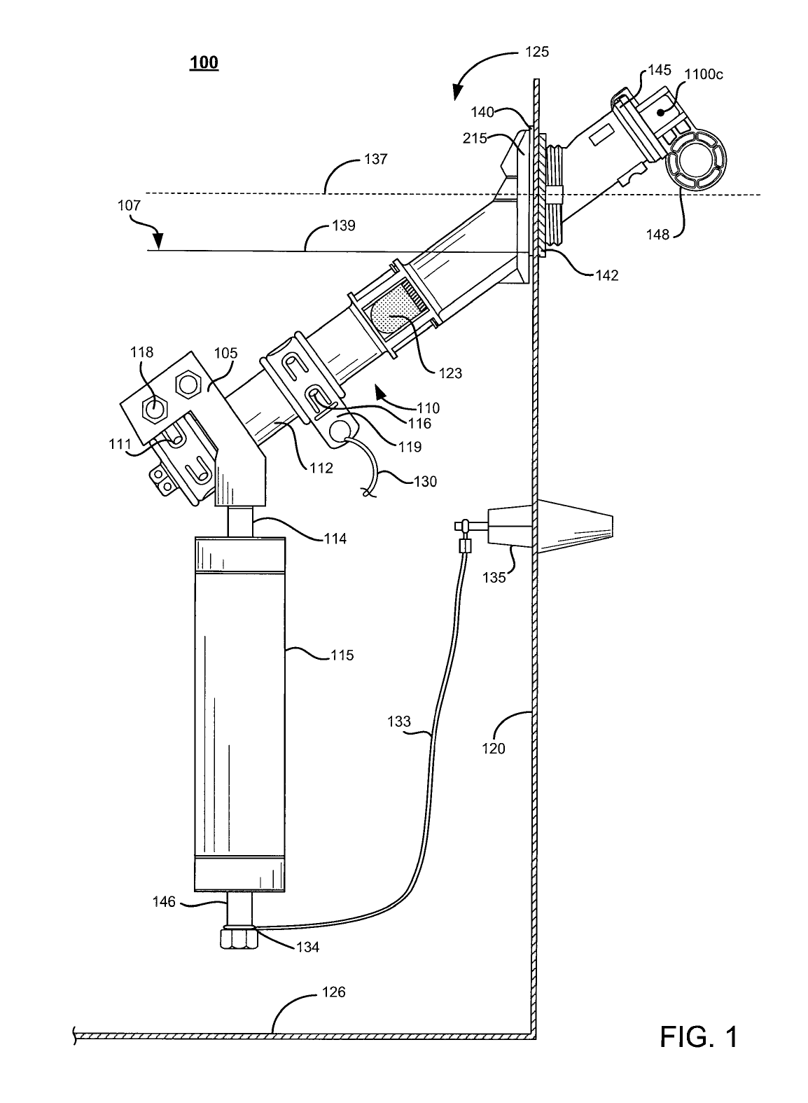

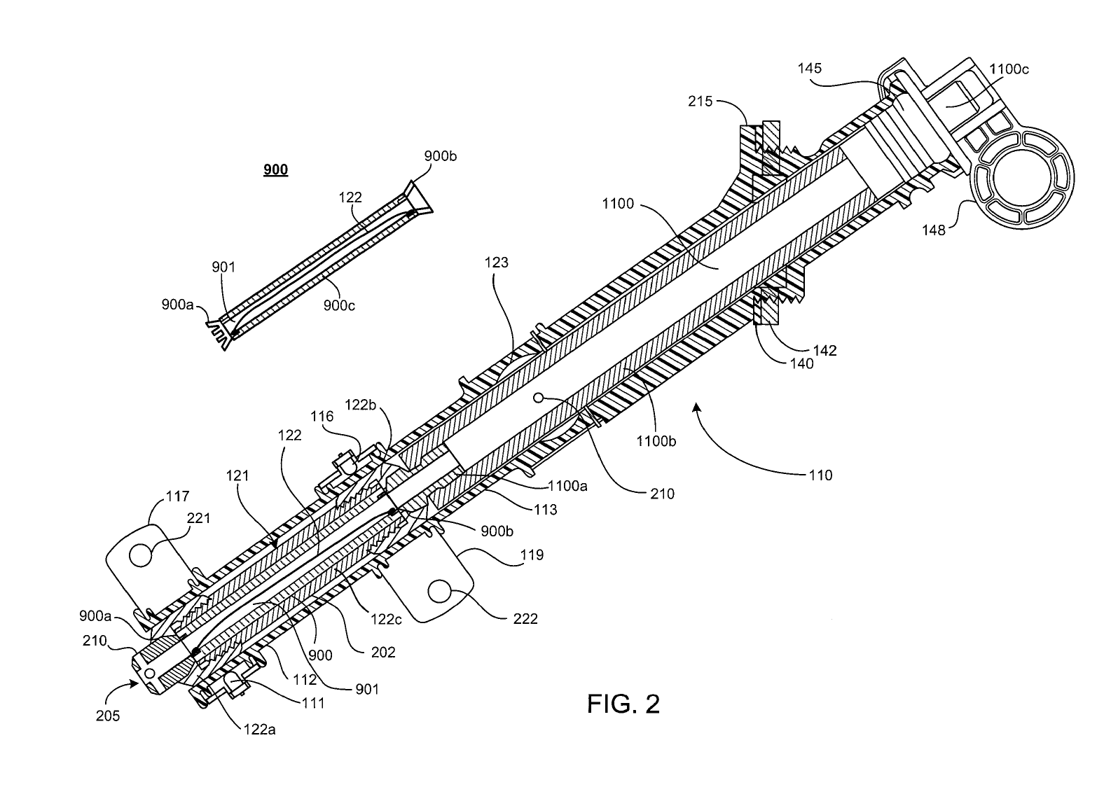

FIG. 1 shows a system 100 that includes a mounting bracket 105 mounted to a fuse assembly 110. FIG. 2 shows a cross-sectional view of the fuse assembly 110 and a cross-sectional view of a fuse link 900 within the fuse assembly 110. When the mounting bracket 105 is mounted to the fuse assembly 110, a current limiting device 115 is mechanically secured to the fuse assembly 110 and electrically connected to a contact 117 on a body 112 of the fuse assembly 110. The fuse assembly 110 is mounted through a side wall 120 of a tank 125 that is filled with a fluid 107. The fluid may be, for example, a mineral oil or some other dielectric fluid. The tank 125 and the components in the tank 125 may be part of a transformer.

The fuse assembly 110 includes a stationary housing 113 made up of the body 112 with the contact 117 and a contact 119. The body 112 may be referred to as an outer tube or an outer housing. As shown in FIG. 1, the mounting bracket 105 mounts about the body 112. The mounting bracket 105 is made from an electrically conductive material. As shown in FIG. 2, the fuse assembly 110 further includes a fuse holder 121, which may be removable from the fuse assembly 110. The fuse holder 121 includes an inner fuse cartridge holder assembly 1100 (which also may be referred to as a fuse stab 1100) and a fuse cartridge 202.

The inner fuse cartridge holder assembly 1100 includes a handle 148, a sealing member 145, a gasket 140, and a lock nut 142. The fuse stab 1100 includes an end plug 1100a, a stab body 1100b, a connective insert 1100c, and a gas port 210 (or fluid port 210). The sealing member 145 is mounted on the stab body 1100b, which has an end plug 1100a securely assembled in a lower bore of the stab body 1100b and a connective insert 1100c in a top end.

The fuse cartridge 202 includes fuse cartridge ends 122a and 122b, a fuse tube 122c, and a fuse link 900. The fuse link 900 includes fuse link end contacts 900a and 900b, a fuse link tube 900c that defines a bore 901, and a fuse wire 122.

When mounted to the fuse assembly 110, the mounting bracket 105 electrically connects an end cap 114 of a current limiting device 115 (such as a current limiting fuse) to the contact 117 of the fuse assembly 110 such that, when the mounting bracket 105 is mounted about the body 112, the current limiting device 115 is electrically connected to the fuse cartridge assembly 202. In the example of FIG. 1, the mounting bracket 105 is electrically and physically connected to the contact 117 through a fastener 118.

When the mounting bracket 105 is mounted about the body 112 and connected to the contact 117, an electrical circuit is formed between a coil (not shown) connected to a lead 130, the mounting bracket 105, and the current limiting device 115. The lead 130 is connected to the contact 119, thus providing an electrical connection between the mounting bracket 105 and the coil through the fuse wire 122. The current limiting device 115 is electrically connected to a high-voltage bushing 135 though a lead 133. The lead 133 is electrically connected to the current limiting device 115 at a connection point 134. The connection point 134 may include a hex-head bolt that secures the lead 133 to an end cap 146 of the current limiting device 115. In use, power may enter the system 100 through the bushing 135, pass through the current limiting device 115 and into the bracket 105, travel through the bracket 105 to the bottom contact 117 and into the fuse cartridge 202, pass through the fuse wire 122 and exit through the top contact 119, and travel to the coil connected to the lead 130.

To assemble the system 100, the fuse assembly 110 is placed through an opening in the tank wall 120, and the opening is sealed with the gasket 140 to prevent the flow of fluid 107 from inside the tank 125 to the exterior of the tank 125. The tank 125 is filled with fluid 107 to a height 137, though in some examples more or less fluid may be used. For example, the tank 125 may be filled with fluid to a height 139. On the exterior of the tank 125, the lock nut 142 secures the fuse assembly 110 in the wall 120. In the example shown in FIG. 1, the fuse assembly 110 is held at an angle of approximately 53° from the tank wall 120, although other angles are possible.

Referring again to FIG. 2, the body 112 of the fuse assembly 110 includes the contacts 117 and 119, each of which are electrically connected, respectively, by spring-loaded contact buttons 111 and 116 to the fuse cartridge ends 122a and 122b. The fuse cartridge ends 122a and 122b are electrically connected, respectively, to the end contacts 900a and 900b (each of which have electrical contacts) of the fuse link 900. The fuse cartridge end 122a is electrically connected to the contact of the fuse link end contact 900a by the end plug 205. The fuse cartridge end 122b is electrically connected to the fuse link end contact 900b by the stab end plug 1100a. The fuse wire (or fuse link or fuse element) 122 is electrically connected to the fuse link end contacts 900a and 900b by soldering or other known electrical connection techniques.

Thus, because the fuse wire 122 is electrically connected to the end contacts 900a and 900b, which are respectively electrically connected to the fuse cartridge ends 122a and 122b that are connected to the contacts 117 and 119, the contacts 117 and 119 on the body 112 are electrically connected through the fuse wire 122. During fuse operation, the fuse wire 122 melts or otherwise is broken such that the wire 122 separates to prevent current from flowing from the fuse link contact 900a to the contact 900b.

The fuse wire 122 is inside the bore 901 of the fuse link tube 900c. The fuse link tube 900c is made from a high-strength, mechanical shock resistant, non-tracking material such as TEFLON that directs and contains gases during fuse operation. The electrically conductive end contacts 900a and 900b of the fuse link 900 may be cone-shaped to facilitate connection of the fuse link 900 to the fuse cartridge assembly 202. The fuse cartridge 202 is made of a high-strength dielectric tube 122c (the fuse tube 122c) and includes the two conductive ends 122a and 122b. The fuse cartridge ends 122a and 122b may include tapered leading and trailing edges to facilitate insertion and removal of the fuse cartridge 202 past the spring loaded contact buttons 111 and 116 on the stationary housing 113 contacts 117 and 119.

The contacts 117 and 119 may be referred to as terminals and the contacts 117 and 119 are configured to connect to high-voltage leads and connections. The contacts 117 and 119 are electrically conductive and may be made from a solid, electrically conductive material or the contacts 117 and 119 may be plated with an electrically conductive material, such as copper, silver, or a combination thereof. The contacts 117 and 119 have respective openings 221 and 222 that are sized to receive a conductive fastener (such as bolt or screw or the fastener 118) that makes electrical contact with the mounting bracket 105. The fuse assembly 110 also may include the flapper valve 123, which is open when the fuse holder 121 is inserted and closed when the fuse holder 121 is removed to reduce an amount of oil or fluid spilled from the fuse assembly 110.

The fuse holder 121 also includes an end plug 205 and fluid ports 210. The end plug 205 includes a threaded end (not shown) that makes contact with the fuse link end contact 900a, which is electrically connected to the fuse wire 122. The end plug 205 also diverts gases during fault interruption. The fluid ports 210 (which may be referred to as gas ports) release gas during fuse operations and prevent excess pressure on the fuse holder 121. The fluid ports 210 in the stab body 1100b are open to an exterior of the fuse assembly 110 through holes in the body 112 at the area where the flapper valve 123 may be assembled. In the example shown in FIG. 2, the fluid ports 210 are located at the lower end of the stab body 1100b aligned with openings in the body 112 where the flapper valve 123 may be installed.

The fuse assembly 110 includes a flange 215 that interacts with the gasket 140 in a compressed state during, for example, assembly. As shown in FIG. 1, the gasket 140 is retained on the inside of the tank 125 to seal the opening in which the fuse assembly 110 is placed. As discussed above with respect to FIG. 2, the inner fuse cartridge holder assembly 1100 includes the sealing member 145 and the handle 148. The sealing member 145 may be, but is not limited to, a multiple-groove Nitrile rubber seal. The opening in the tank may be sealed by compressing the sealing member 145 in an axial direction by cam action of the handle 148. The handle 148 is a hot or hook stick-operable handle that may be used to seal and unseal the fuse assembly 110 and/or to remove or place the fuse assembly 110 in the wall 120 and/or to remove or install the fuse holder 121, perhaps under hot operation. For example, a hot stick may be inserted into an opening in the handle 148 to remove the fuse assembly 110, thus opening the circuit, while the transformer is energized. In another example, the handle 148 may be used to remove the fuse holder 121 from the fuse assembly 110 such that the fuse holder 121 may be, for example, replaced without disturbing the current limiting device 115.

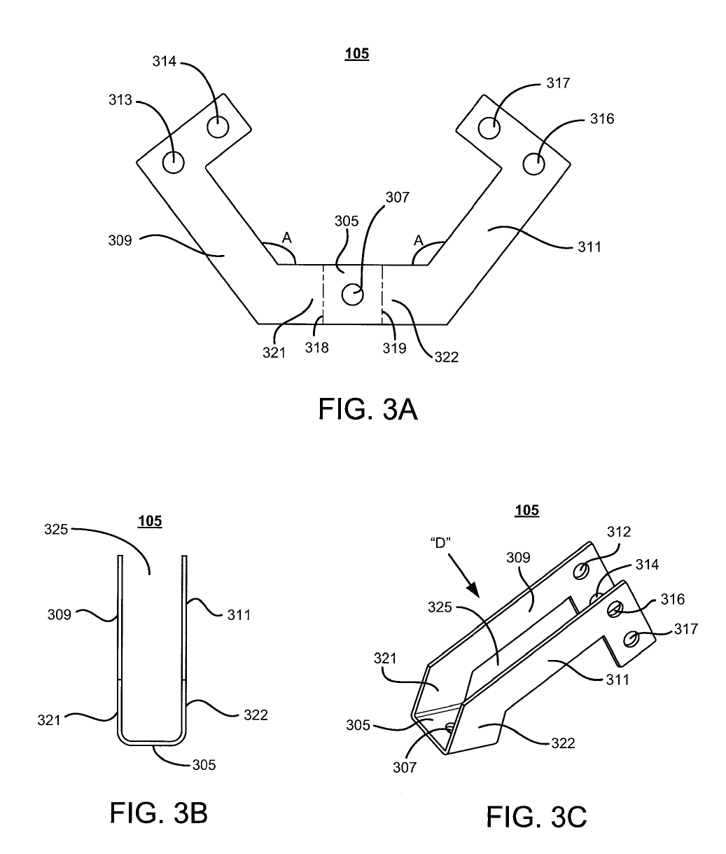

Referring to FIG. 3A, the mounting bracket 105 is shown after being stamped out or otherwise formed during manufacture. After initial formation, the mounting bracket 105 may be flat, or almost flat, and FIG. 3A shows the mounting bracket in this initial state.

The mounting bracket 105 includes an end portion 305 that includes a bore 307 configured to connect to the end cap 114 of the current limiting device 115 as shown in FIG. 1. The bore 307 may be a smooth opening that passes through the end portion 305. Bore 307 is sized to receive a conductive fastener (such as a bolt or a screw) that, when tightened or otherwise fastened, makes electrical contact with the mounting bracket 105 and the current limiting device 115. The mounting bracket 105 also includes a first side 309 and a second side 311, both of which are connected to the end portion 305. In the example shown, two openings 313 and 314 are formed in the first side 309, and two openings 316 and 317 are formed in the second side 311.

The mounting bracket 105 may be stamped out from a solid sheet of metal or other conductive material or the mounting bracket 105 may be formed by connecting or coupling more than one piece of conductive material together. The stamped out mounting bracket 105 may be folded or otherwise bent at locations 318 and 319 to shape the mounting bracket 105 for positioning about the body 112 of the fuse assembly 110. The stamped out mounting bracket 105 may be bent at 90-degree angles relative to the end portion 305 such that, once formed, the first side 309 and the second side 311 are substantially parallel to each other and form an opening that receives the body 112 of the fuse assembly 110.

In some implementations, the first side 309 and the second side 311 are angled at an angle “A,” which may be approximately 127 degrees. Angling the first side 309 and the second side 311 results in the mounting bracket 105 including flanges 321 and 322 that hold the current limiting device 115 at the angle “A” relative to a longitudinal axis of the body 112 of the fuse assembly 110. Mounting the current limiting device 115 at the angle “A” results in a dampening of mechanical vibrations and a corresponding reduction in motion of the current limiting device 115. Thus, by holding the current limiting device 115 at the angle “A,” motion of the current limiting device 115 may be eliminated or greatly reduced.

Reduction or elimination of motion of the current limiting device 115 may result in a system that is more robust and easier for the purchaser to set up and implement. For example, the system 100 shown in FIG. 1 may be assembled prior to purchase and shipped to the end-user as a complete unit. Forming the mounting bracket 105 such that the current limiting device 115 is held at the angle “A” may help to ensure that the complete system is transported to the end-user without the current limiting device 115 snapping off, being damaged, or causing damage to other portions of the tank 125 during transit. Additionally, holding the current limiting device 115 at the angle “A” may impart benefits during operation of the system 100. For example, if the tank 125 is bumped during operation, the current limiting device 115 stays in position.

Referring to FIG. 3B, a side view of the mounting bracket 105, formed into a shape that accommodates the body 112 of the fuse assembly 110, is shown. FIG. 3B shows the mounting bracket 105 along the direction “D” as labeled in FIG. 3C. Referring to FIG. 3C the openings 312, 316 and 314, 317 correspond to each other such that a fastener (such as a bolt) that has sufficient length to pass through the first side 309 and the second side 311, passes through one of the openings 312, 316 and 314, 317 and also passes through the other of the openings 312, 316 and 314, 317, respectively. In FIG. 1, the fastener 118 passes through the openings 314 and 317 to electrically connect the mounting bracket 105 to the contact 117. Arrangement of the openings in this manner allows the mounting bracket 105 to be secured to the body 112 of the fuse assembly 110. Additionally, an opening 325 is formed such that the mounting bracket 105 may accept the body 112 of the fuse assembly 110.

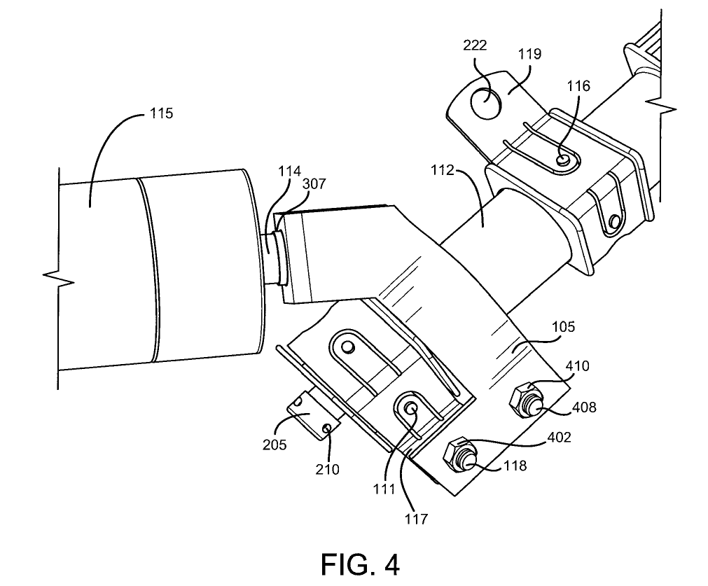

Referring to FIG. 4, a perspective view of the mounting bracket 105 is shown. As compared to FIG. 1, the view shown in FIG. 4 shows an underside of the mounting bracket 105. The fastener 118 passes through openings 317 and 314 (FIG. 3C) formed in the bracket 105 and through the opening 221 (FIG. 2) formed in the contact 117 and, in this example, the fastener 118 is secured with a nut 402. Additionally, a fastener 408 passes through the openings 312 and 316 formed in the mounting bracket 105 and is bolted with a nut 410 to further secure the fuse assembly 110 to the body 112 of the fuse assembly 110. In this example, the contacts 117 and 119 have spring loaded contact tabs formed on the contacts, with conductive arc resistant contact buttons 111 and 116 secured on the end. As discussed above with respect to FIGS. 1 and 2, the spring loaded contact buttons 111 and 116 electrically connect the contacts 117 and 119 to the fuse cartridge assembly ends 122a and 122b, respectively, on the fuse holder 121.

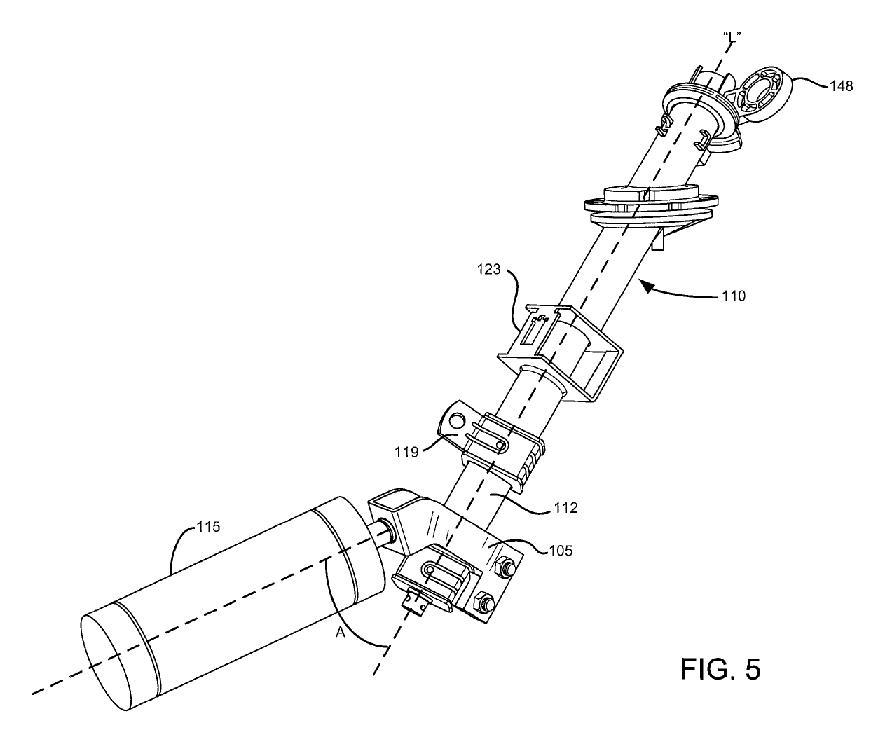

FIG. 5 shows a perspective view of an assembly that includes the fuse assembly 110 electrically and physically connected to the current limiting device 115 by way of the mounting bracket 105. The mounting bracket 105 holds the current limiting device 115 at the angle “A” relative to a longitudinal axis “L” of the fuse assembly 110. As discussed above, holding the current limiting device 115 at the angle “A” reduces mechanical vibrations and further secures the current limiting device 115 to the fuse assembly 110.

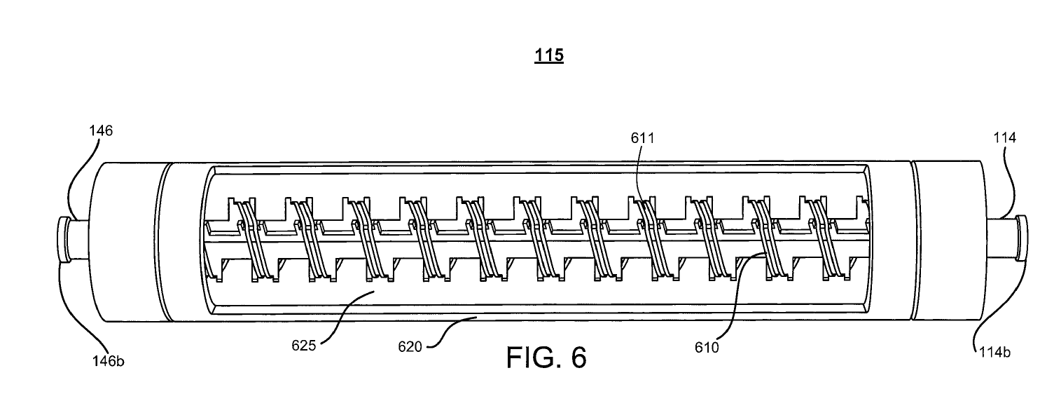

FIG. 6 shows a cross-sectional view of an example current limiting device 115. In this example, the current limiting device 115 is a current limiting fuse (CLF). The current limiting device 115 includes the end cap 114 and an end cap 146, both of which may be conductive end caps, a fuse ribbon 610 that electrically connects the end cap 114 to the end cap 146, a housing 620, and a filler material 625. In this example the end caps 114 and 146 have two conductive, threaded sealing bosses 114b and 146b. The seal may be made through a known technique, such as soldering. In other examples fuse caps, the internal or external threads may be formed into a one piece cap.

The end cap 114 and the end cap 146 may be solid copper end caps with conductive inserts made from, for example, copper or brass. In some implementations, one or both of the end cap 114 and the end cap 146 may be threaded. The fuse ribbon 610 may be made from silver or another material that is stable when exposed to current cycling and thermal stress and that separates under relatively consistent conditions. The fuse ribbon 610 may include ribbon holes, notches, or deformations 611 that control and minimize peak arc voltages that result from current interruptions. The housing 620 may be made from fiberglass or another material that withstands and maintains the integrity of the housing when exposed to pressures and forces resulting from clearing currents of up to 50 kA and beyond. The filler 625 may be a material that absorbs heat and aids in quenching arcs. The filler 625 may be a silica sand.

Referring also to FIG. 4, the mounting bracket 105 is electrically connected to the current limiting device 115 at the conductive end cap 114. The current limiting fuse end cap 114 includes a conductive threaded boss 114b (FIG. 6) that seals the end cap 114 and provides a connection between the current limiting device 115 and the mounting bracket 105. In some implementations, the current limiting device 115 is connected to the bracket 105 by passing a ¼″-20 bolt though the bore 307 and threading the bolt into the threaded boss 114b of the current limiting device 115. Bolts of other sizes and other types of fasteners may be used. Once connected, the current limiting device 115 is electrically connected to the mounting bracket 105, which is electrically connected to the fuse holder 121 through the contact 117. Accordingly, the mounting bracket 105 electrically connects the current limiting device 115 to the fuse cartridge assembly 202.

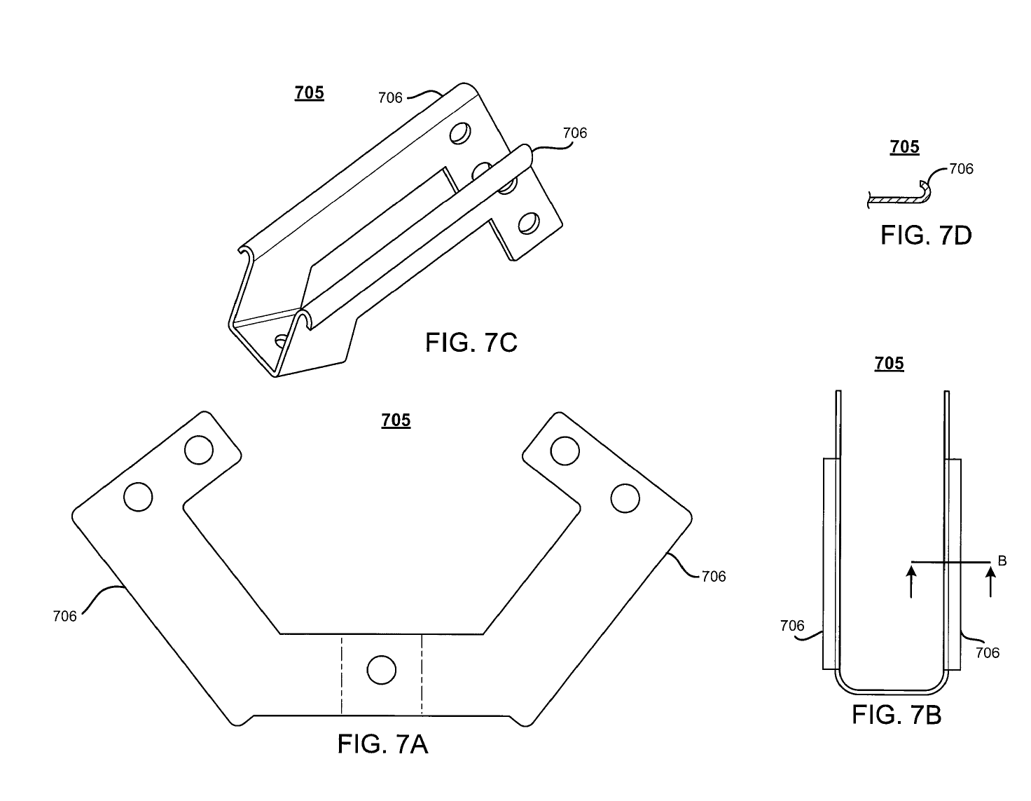

FIGS. 7A-7C show another implementation of a mounting bracket. The mounting bracket 705 is similar to the mounting bracket 105 except that the mounting bracket 705 includes rounded edges 706 that increase a withstand capability of the fuse assembly 110 between the top contact 119 and the rounded edge 706 of the mounting bracket 705. The withstand capability of the fuse assembly 110 is the maximum voltage impulse that may be withstood between the contact 117 and the contact 119.

As shown FIG. 2, the contact 117 and the contact 119 are separated by a distance. A relatively short distance between the contact 117 and the contact 119 is desirable to, for example, achieve a smaller fuse assembly 110, which allows for a corresponding reduction in, for example, the size of the tank 125. However, if the distance between the contacts 117 and 119 is too short, an arc may form outside of the fuse assembly 110 and between the contact 117 and the contact 119 when the fuse holder 121 is activated. To increase the minimum voltage at which arcing occurs while also retaining the contact 117 and the contact 119 at a relatively close spacing to each other, one or more voltage grading methods between the contacts 117 and 119 may be used.

The presence of the one or more voltage gradings allows the fuse assembly 110 to withstand a higher voltage potential difference without arcing than an implementation of the fuse assembly 110 that does not include the one or more voltage gradings. For example, use of the voltage grading may allow the fuse assembly 110 to withstand up to about, but not limited to, a 45 kV high pot level without increasing the distance between the contacts 117 and 119.

The voltage grading may be formed by rounding the edges of the mounting bracket 105 that are closest to the contact 119, by placing a spring in electrical contact with the mounting bracket 105 and between the mounting bracket 105 and the contact 119, or by adding skirts to the body 112 of the fuse assembly 110. These techniques are discussed in turn, respectively, in FIGS. 7A-7C, FIGS. 8 and 9, and FIG. 10.

FIG. 7A shows a developed view of the mounting bracket 705, FIG. 7B shows a formed view of the mounting bracket 705, FIG. 7C shows a perspective view of the mounting bracket 705, and FIG. 7D shows one of the rounded edges 706 along the line “B.” The rounded edges 706 are on the side of the mounting bracket that is closer to the contact 119. The rounded edges 706 may be formed by rolling the edges of the mounting bracket 705 to about, but not limited to, a radius between about 0.10 and 0.375 inches (between about 0.265 and 0.9525 centimeters). For example, in some implementations, the radius of the rounded edges 706 may be 0.25 inches (0.635 cm). The rounded edges 706 are rolled away from the contact 119. In some implementations, one of the two edges may be rounded.

The mounting brackets 105 and 705 conduct electricity and are made from any suitable electrically conductive material having sufficient strength to support the current limiting device 115. In some implementations, the conductive material may be dead soft copper. In some implementations, the conductive material may be ¼ Hard copper, which may result in the mounting bracket 105 or 705 being stronger (perhaps 4-5 times stronger) than a bracket made from dead soft copper. In other implementations, the mounting bracket 105 or 705 may be made from copper-plated or silver-plated steel.

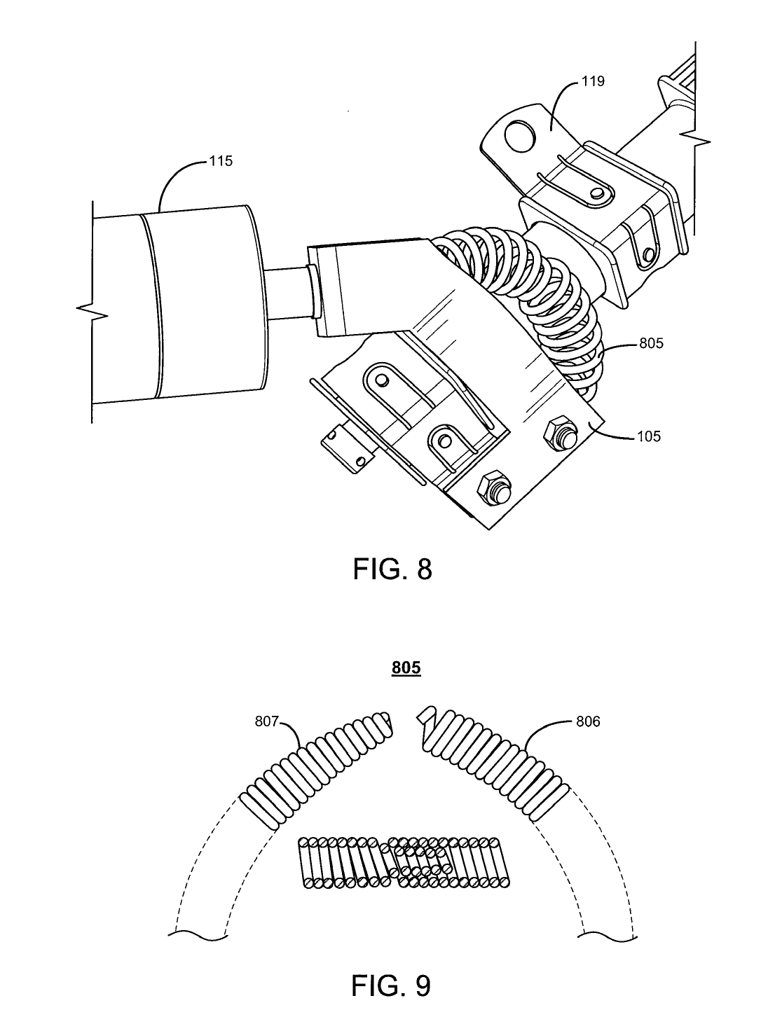

FIGS. 8 and 9 show a spring 805 disposed between the mounting bracket 105 and the contact 119 to form a voltage grading. The spring 805 is made from a conductive material and includes ends 806 and 807. The ends 806 and 807 may be placed in an interference fit between the body 112 of the fuse assembly 110 and the mounting bracket 105 such that the spring 805 makes electrical contact with the mounting bracket 105. The spring 805 may be referred to as a voltage grading spring.

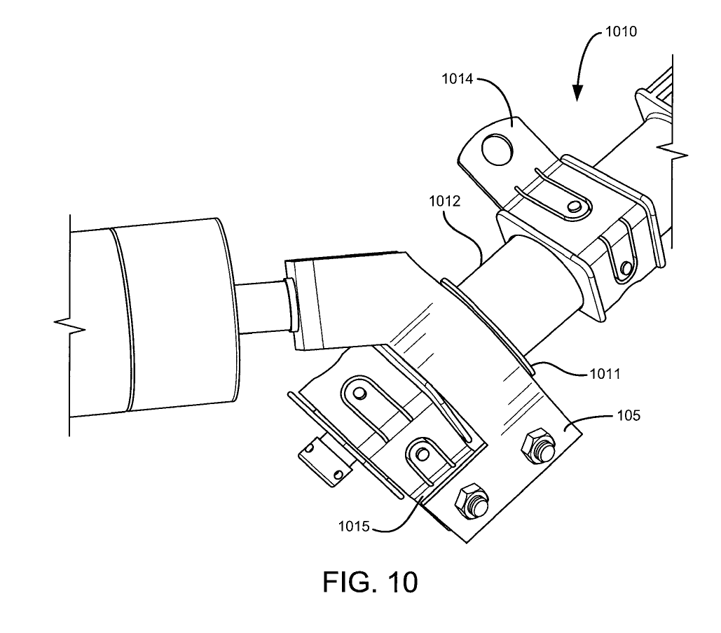

FIG. 10 shows an alternative implementation of a fuse assembly 1010. As compared to the fuse assembly 110, the fuse assembly 1010 includes a body 1012 on which one or more skirts 1011 are formed. The mounting bracket 105 is mounted to the body 1012. The fuse assembly 1010 includes an upper contact 1014 and a lower contact 1015. The upper contact 1014 and the lower contact 1015 are both electrically connected to a fuse link, such as the fuse link 122, and the upper contact 1014 and the lower contact 1015 are placed along the fuse assembly 1010 similarly to how the contacts 117 and 119 are arranged relative to each other on the fuse assembly 110.

The skirt 1011 is between the mounting bracket 105 and an upper contact 1014 such that the skirt 1011 acts as a creep distance extender and increases the withstand capability of the fuse assembly 1010. The skirt 1011 adds creep distance between the upper contact 1014 and the mounting bracket 105 without significantly adding to the physical distance that separates the upper contact 1014 and the lower contact 1015. The skirt 1011 may be molded directly into the body 1012 of the fuse assembly 1010.

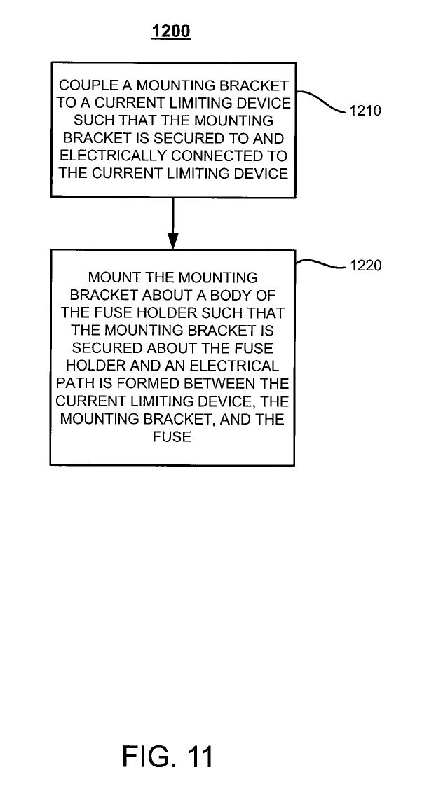

FIG. 11 shows an example of a process for electrically and mechanically mounting a current limiting device 115 to a body 112 of a fuse assembly 110. The end portion 305 of the mounting bracket 105 is coupled or otherwise connected to the current limiting device 115 such that the mounting bracket 105 is secured to and electrically connected to the current limiting device 115 (1210). The current limiting device 115 may be coupled to the bracket 105 by connecting the current limiting device 115 to the bracket 105 by passing a ¼″-20 bolt through the bore 307 in the bracket 105 and into the threaded boss 114b of the current limiting device 115. Connection in such a manner results in the current limiting device 115 being electrically and mechanically connected to the bracket 105. The mounting bracket 105 is mounted about the body 112 of the fuse assembly 110 such that the mounting bracket 105 is secured about the fuse assembly 110 and an electrical path is formed between the current limiting device 115, the mounting bracket 105, and the fuse holder 121 (1220).

The mounting bracket 105 may be secured about the fuse assembly 110 by passing the fastener through the openings 314 and 317 of the mounting bracket 105 and through the opening 221 of the contact 117 such that the fastener makes electrical contact with the contact 117. The end portion 305 of the mounting bracket 105 may be coupled to the current limiting device 115 by threading a threaded end of the current limiting device 115 to a threaded bore 307 formed in the end portion 305.

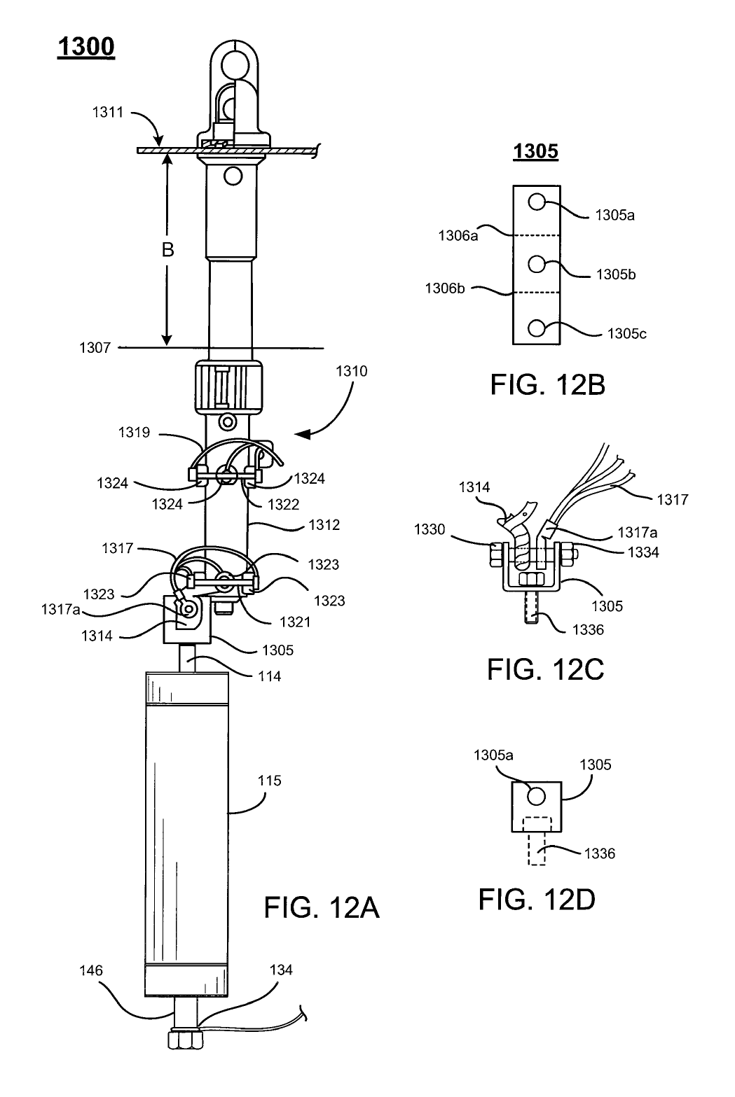

FIG. 12A shows another example system 1300 that includes a mounting bracket 1305 mounted to a fuse assembly 1310. The mounting bracket 1305 is made from an electrically conductive material, such as ¼ Hard copper or dead soft copper. The mounting bracket 1305 electrically and mechanically connects the current limiting device 115 and the fuse assembly 1310. The fuse assembly 1310 is mounted in a tank 1311 by passing the fuse assembly 1310 through an opening in the top of the tank 1311 or a cover that covers the top of the tank 1311. As shown in FIG. 12A, the fuse assembly 1310 is placed vertically, or nearly vertically, in the tank 1311. The tank 1311 is filled with a fluid to a fluid level 1307 that is a distance “B” below the top of the tank 1311.

The fuse assembly 1310 includes a body 1312 with contact leads 1317 and 1319, and a molded portion 1314. Springs 1321 and 1322 encircle the body 1312 of the fuse assembly 1310 and hold contact buttons 1323 and 1324, respectively, in place. In the example shown in FIG. 12A, each of the contact buttons 1323 and 1324 include four separate contact buttons, three of which are shown in FIG. 12A. The contact buttons 1323 are held to the body 1312 with the spring 1321, and the contact buttons 1324 are held to the body 1312 with the spring 1322. The contact lead 1317 is electrically connected to the contact buttons 1323 and the contact lead 1319 is electrically connected to the contact buttons 1324. Similar to the contacts 117 and 119 of the fuse assembly 110 discussed above, the contact leads 1317 and 1319 of the fuse assembly 1310 are electrically connected to each other through a fuse wire (not shown) that is internal to the fuse assembly 1310 and that electrically connects the contact buttons 1323 to the contact buttons 1324. The contact leads 1317 and 1319 each include a connection interface, such as a connection interface 1317a, which may be a crimp connection.

Referring to FIG. 12B, the mounting bracket 1305 includes openings 1305a, 1305b, and 1305c. The mounting bracket 1305 is bent about the locations 1306a and 1306b to form the formed mounting bracket 1305 shown in FIG. 12C. In the example shown in FIG. 12C, the mounting bracket 1305 is bent at the locations 1306a and 1306b at an angle of about 90° such that the openings 1305a and 1305c align with each other. However, in other examples, the mounting bracket 1305 may be bent at another angle.

Referring to FIGS. 12A and 12C, the bracket 1305 is electrically connected to the contact lead 1317 by aligning the openings 1305a and 1305c with an opening (such as the connection interface 1317a) of the contact lead 1317 and passing a bolt 1330 through the opening 1305a, the connection interface 1317a, and the opening 1305c of the bracket 1305. The bolt 1330 is secured with a nut 1334. The bolt 1330 is made of an electrically conductive material and makes physical contact with the connection interface 1317a such that the contact lead 1317 is electrically connected to the bracket 1305.

The molded portion 1314 of the fuse assembly 1310 is also secured to the bracket 1305 by passing the bolt 1330 through an opening in the molded portion 1314. The molded portion 1314 is made of a flexible material that bends into the bracket 1305 such that the current limiting device 115 is aligned vertically, or substantially vertically, in the tank 1311. In other implementations, the molded portion 1314 is rigid and protrudes from the body 1312 at an angle that is perpendicular to a surface of the body 1312 such that the bracket 1305 holds the current limiting device 115 horizontally, or approximately horizontally, in the tank. The molded portion 1314 may protrude from the surface of the body 1312 at any angle, and in examples in which the molded portion 1314 is rigid, the current limiting device 115 is held at an angle relative to the top of the tank 1311 that is determined by the angle at which the molded portion 1314 protrudes from the surface of the body 1312. The molded portion 1314 may be made of a material that does not conduct electricity.

The current limiting device 115 is electrically connected to the bracket 1305 by connecting the end cap 114 to a bolt 1336 that passes through the opening 1305b of the bracket 1305. The bolt 1336 may be threaded into the threaded boss 114b of the current limiting device 115. FIG. 12D shows a side view of the mounting bracket 1305 without the bolt 1330 and also illustrates how the bolt 1336 is disposed in the mounting bracket 1305 for connection to the current limiting device 115.

Once mounted to the fuse assembly 1310 by way of the mounting bracket 1305, the current limiting device 115 is electrically connected to the contact lead 1317 and mechanically connected to the body 1312.

Other implementations are within the scope of the claims. For example, the fuse assembly 110 may have a one-inch cross-sectional diameter. More than one skirt 1011 may be formed on the fuse assembly 1010. Multiple of the voltage gradings discussed with respect to FIGS. 7A-7C and 8-10 may be employed on a single fuse assembly. Any or all of the voltage gradings discussed with respect to FIGS. 7A-7C and 8-10 may be employed on the fuse assembly 1310.

The fuse assembly 110 may be a Bay-O-Net fuse assembly, available from Cooper Power Systems™. The flapper valve 123 may be an optional feature and the fuse assembly 110 may be formed without the flapper valve 123. The system 100 shown in FIG. 1 may include a tank cover, and the fuse assembly 110 may be mounted through that tank cover.

The angle “A” shown in FIG. 5 may be an angle other than 127 degrees. For example, the angle “A” may be such that the current limiting device 115 is positioned vertically in the tank 125 parallel to the tank wall 120. In another example, the angle “A” may be such that the current limiting device 115 is positioned horizontally in the tank 125, with cap 146 toward the back of the tank 125. Such an arrangement minimizes the distance required from the lower surface of the fuse to the tank bottom 126. The current limiting device 115 may be mounted with the end cap 146 near the tank front wall 120 and parallel to the center line of the fuse assembly 110. Such an arrangement provides a relatively compact design. In some implementations, the mounting bracket 105 may be configured to mount the current limiting device 115 vertically above the lower contact 117, with the current limiting device 115 end cap 114 toward the surface of the fluid 107 at the height 137 or 139. In these implementations, the current limiting device 115 is sized such that the device 115 remains in the fluid 107 despite being oriented vertically towards the top of the tank 125.

The fuse assembly 110 may include any type of submersible or under-fluid expulsion fuse, such as an under-oil expulsion fuse. For example, the fuse link 900, included in the fuse cartridge 202, may be an under-oil expulsion fuse. The fuse link 900 may be a fault or thermal actuating fuse.

What is claimed is:

1. An assembly comprising:
an electrically conductive mounting bracket;
a current limiting device electrically connected to the mounting bracket; and
a fuse assembly comprising a body and a fuse, wherein the electrically conductive mounting bracket is configured to mount about the body of the fuse assembly, and, when the electrically conductive mounting bracket is mounted about the body of the fuse assembly, the mounting bracket forms a path for electrical current between the current limiting device and the fuse.

2. The assembly of claim 1, wherein the current limiting device comprises a current limiting fuse.

3. The assembly of claim 2, wherein the current limiting fuse comprises a protrusion configured to connect to a portion of the mounting bracket.

4. The assembly of claim 1, wherein the body includes a first contact and a second contact, both of which are electrically connected to the fuse, and the mounting bracket is electrically connected to the first contact.

5. The assembly of claim 1, wherein the mounting bracket comprises an end, a first side connected to the end, and a second side connected to the end, the first side and the second side define an opening configured to be placed about the body of the fuse assembly.

6. The assembly of claim 5, wherein the mounting bracket is formed from a single piece.

7. The assembly of claim 5, wherein a bore configured to receive a portion of the current limiting device is formed in the end, a first opening is formed in the first side, and a second opening is formed in the second side.

8. The assembly of claim 7, wherein the first opening comprises two separate openings that pass through the first side, and the second opening comprises two separate openings that pass through the second side.

9. The assembly of claim 8, wherein a fastener connects one of the openings on the first side to one of the openings on the second side to secure the mounting bracket about the body of the fuse assembly, and a conductive connector accepted into the other one of the openings on either of the first side and the second side makes an electrical connection to the fuse included in the fuse assembly.

10. The assembly of claim 1, wherein the mounting bracket is configured to hold the current limiting device at a predetermined angle relative to a longitudinal axis of the body of the fuse assembly.

11. The assembly of claim 1, wherein the fuse assembly comprises a first contact and a second contact, both of which are electrically connected to the fuse, and the fuse assembly withstands up to a first potential difference between the first contact and the second contact without producing an arc between the first contact and the second contact.

12. The assembly of claim 11, wherein the body of the fuse assembly further comprises a voltage grading configured to allow the fuse assembly to withstand a second potential difference between the first contact and the second contact without producing an arc between the first contact and the second contact, the second potential difference being greater than the first potential difference.

13. The assembly of claim 12, wherein the voltage grading comprises a voltage grading spring.

14. The assembly of claim 12, wherein the voltage grading is formed by rounding a portion of an edge of the mounting bracket.

15. The assembly of claim 12, wherein the voltage grading comprises a skirt that increases a creep distance between the mounting bracket and one of the first and second contacts and that is included on the body of the fuse assembly.

16. A mounting bracket for electrically and mechanically connecting a current limiting device to a body of a fuse assembly, the mounting bracket comprising:
an end portion configured to join the mounting bracket to the current limiting device and, once joined, to electrically connect the mounting bracket to the current limiting device; and
a side portion attached to the end portion and configured to mount about the body of the fuse assembly such that, once the side portion is mounted about the body, a path for electrical current is formed between a fuse included in the fuse assembly, the mounting bracket, and the current limiting device.

17. The mounting bracket of claim 16, further comprising a second side portion connected to the end portion, the second side portion being substantially parallel to the side portion.

18. The mounting bracket of claim 16, wherein the end portion is angled relative to the side portion such that, once the side portion is mounted about the body, the current limiting element is held at an angle relative to a longitudinal axis of the body of the fuse assembly.

19. The mounting bracket of claim 18, wherein the side portion comprises a rounded edge.

20. A method of electrically and mechanically connecting a current limiting device to a fuse included in a fuse assembly the method comprising:
coupling a mounting bracket to the current limiting device such that the mounting bracket is secured to and electrically connected to the current limiting device; and
mounting the mounting bracket about a body of the fuse assembly such that the mounting bracket is secured about the fuse holder and an electrical path is formed between the current limiting device, the mounting bracket, and the fuse.

21. A system comprising:
a tank;
a fuse assembly mounted in the tank;
a mounting bracket mounted about the body of the fuse assembly; and
a current limiting device electrically and mechanically coupled to a fuse within the fuse assembly through the mounting bracket, the mounting bracket holding the current limiting device at an angle relative to a longitudinal axis of the body of the fuse assembly.

22. The system of claim 21, wherein the fuse assembly is mounted through one of a side wall or a top of the tank.
